(19) United States
(12) Patent Application Publication
(10) Pub. No.: US 2025/0035571 A1
(43) Pub. Date: Jan. 30, 2025

(54) TRANSIENT THERMAL CHARACTERISATION OF BODIES

(71) Applicant: Imperial College Innovations Limited, London (GB)

(72) Inventors: Gavin White, London (GB); Alistair Hales, London (GB); Yatish Patel, London (GB); Gregory Offer, London (GB)

(73) Assignee: Imperial College Innovations Limited, London (GB)

(21) Appl. No.: 18/709,354

(22) PCT Filed: Nov. 10, 2022
(86) PCT No.: PCT/EP2022/081419

§ 371 Date: May 10, 2024

(30) Foreign Application Priority Data
Nov. 10, 2021 (GB) 2116173.2

(51) Int. Cl. G01N 25/20

(52) U.S. Cl. CPC G01N 25/20

(57) ABSTRACT

There is provided apparatuses and methods for measuring at least one thermal property of a body. The methods involve causing a symmetrical thermal boundary condition across the body such that measurements taken are not affected by the structure of the body being measured.

### TECHNICAL FIELD

The present application relates to the field of characterising the thermal properties of bodies. In particular, the present application relates to measuring the thermal diffusivity of electrochemical cells, or any other body, which may have non-uniform thermal properties throughout the body.

Current techniques for determining the thermal diffusivity of lithium-ion cells require a thermal gradient to be applied directly or indirectly to a cell. This is fine for most materials as there is only one path for the heat to transfer through, but this can result in errors as much as 30% for lithium-ion cells. This is because lithium-ion cells have multiple heat paths due to the thermally conductive casing materials.

One such known method for measuring the thermal diffusivity of a body involves heating one side of a flat sample with a known energy input. By measuring the temperature rise on the opposite side of the flat sample, the thermal diffusivity can be calculated. A sample that has a higher value of thermal diffusivity will lead to a faster thermal response on the opposite side of the flat sample.

For an electrochemical cell such as a lithium-ion cell, the body is made up of a multiple layers of different materials. These layers may include cathode or anode material, electrolyte, separators, and a casing to hold the cell together. The casing in particular may comprise a material which readily conducts heat. This is of course useful because it is desirable that a lithium-ion cell rejects heat to its environment in order to avoid problems from overheating. However, when measuring the thermal properties of the cell by applying a thermal gradient to the cell, the heat transfer through the casing may skew the results and provide an inaccurate representation of the overall properties of the cell. This is particularly important in the case of characterising the properties of the cell under internal heat generation.

What is needed is a method of characterising the thermal properties of bodies which may be unaffected by the inhomogeneous structure of electrochemical cells.

### SUMMARY

In a first embodiment of the invention there is provided a method of measuring at least one thermal property of a body comprising the steps of: maintaining at least one surface of the body at a constant temperature; controlling an internal heat generation of the body to generate a predetermined heat output for a time period; measuring the heat flux through the at least one surface of the body during the time period; and calculating the thermal property based at least in part on the measured heat flux. By measuring the heat flux of the body under these conditions, thermal properties of the body may be characterised without relying on a thermal gradient across the body. Advantageously, this avoids the method allowing preferential heat transfer through a highly thermally conductive casing, for example.

Optionally, the step of maintaining at least one surface of the body at a constant temperature comprises maintaining a first surface of the body at a constant temperature and maintaining a second surface of the body at a constant temperature.

Optionally, the first surface and the second surface are maintained at the same constant temperature. Since the first surface and the second surface are maintained at the same constant temperature, there is no thermal gradient across the whole of the body. This is advantageous because bodies which have non-uniform properties, such as an electrochemical cell with a thermally conductive casing, will not affect the measurement due to heat passing around the casing preferentially over passing through the body.

Optionally, the first surface and the second surface are selected such that a temperature profile across the body from the first surface to the second surface is symmetrical. By picking surfaces which result in a symmetrical temperature profile across the body, the measurement and characterisation of the thermal properties of the body are not affected by a thermal gradient between the surfaces.

Optionally, the body is an electrochemical cell, and may be one of a prismatic cell, a pouch cell, or a cylindrical cell. Advantageously, the method may be applied to multiple form factors of electrochemical cell. Since the method avoids a thermal gradient across the cell, the measurement is unaffected by a thermally conductive casing, for example.

Optionally, the step of controlling the internal heat generation of the electrochemical cell comprises controlling a current flow in the electrochemical cell. Controlling the current flow in the electrochemical cell may be alternated between a charging current and a discharging current such that the level of charge of the electrochemical cell remains constant over the time period. The current flow may be controlled to generate a constant heat output in the electrochemical cell during the time period. In this way, the condition of the cell may be maintained whilst generating heat internally. Since the state of charge of the cell does not vary, the parameter of cell open circuit voltage, for example, can be eliminated in the calculation of thermal properties of the cell.

Optionally, the heat flux through the at least one surface of the body is measured using one or more heat flux sensors.

Optionally, the measured heat flux over the predetermined time period is fit to the fitting equation:

$$\dot{q} = {\sum }_{n = 1 , 3 , 5 …}^{∞} ( - ( \frac{{\dot{e}}_{g e n} L}{2} ) {( \frac{4}{π n} )}^{2} ) {e}^{- \frac{t}{τ}}$$

wherein \dot{q} is the heat flux, ė_{gen} is the internal heat generation calculated from the current flow, L is the transverse distance between the at least one surface and a central plane of the body, t is the time, and τ is the fitting parameter wherein:

$$τ = \frac{1}{{s}^{2} α} , s = \frac{n π}{2 L} , and α \frac{k}{ρ {c}_{p}} ,$$

and wherein ρ is the density of the body, cₚ is the heat capacity of the body, and k is the thermal diffusivity of the body. The method may further comprise the step of calculating the thermal diffusivity of the body.

Optionally, the thermal diffusivity is calculated by an error minimisation routine to match the measured heat flux to the heat flux calculated by the fitting equation.

Optionally, the thermal diffusivity is calculated by integrating the heat flux during the time period and equating the absorbed energy with the stored energy. The absorbed energy and the stored energy may be equated such that:

$$α = \frac{\dot{Q} {L}^{2}}{3 A \int \dot{q} dt}$$

wherein \dot{Q} is the heat generated in the body, L is the transverse distance between the at least one surface and a central plane of the body, A is the area of the at least one surface, \dot{q} is the heat flux through the at least one surface, t is the time, and:

$$α = \frac{k}{ρ {c}_{p}}$$

wherein ρ is the density of the body, cₚ is the heat capacity of the body, and k is the thermal diffusivity of the body, the method further comprising the step of calculating the thermal diffusivity of the body.

Optionally, the heat capacity of the body is measured by calorimetry.

In a further embodiment, there is provided a method of measuring at least one thermal property of a body comprising the steps of: applying a step-change in temperature to at least one surface of the body from a first temperature to a second temperature; maintaining the at least one surface of the body at the second temperature for a time period; measuring the heat flux through the at least one surface of the body during the time period; and calculating the thermal property based at least in part on the measured heat flux.

Optionally, the step of applying a step-change in temperature comprises heating the at least one surface of the body from the first temperature to the second temperature using a heater.

Optionally, the step of applying a step-change in temperature comprises cooling the at least one surface of the body from the first temperature to the second temperature using a cooler.

Optionally, the at least one surface of the body is maintained at the second temperature for more than 50 times, preferably more than 100 times, and more preferably more than 200 times the amount of time taken to apply the step-change. Advantageously, by increasing the ratio between the step change and the time period, the step change may be closer to a theoretical step change. Whilst a step change in zero time is not possible to achieve, it has been found that making the step change close to ideal improves the resultant heat flux data.

Optionally, the measured heat flux over the predetermined time period is fit to the fitting equation:

$$\dot{q} = {\sum }_{n = 1 , 3 , 5 …}^{∞} ( - \frac{2 k Δ T}{L} ) {e}^{- \frac{t}{τ}}$$

wherein \dot{q} is the heat flux, k is the thermal diffusivity of the body, ΔT is the step-change in temperature, L is the transverse distance between the at least one surface and a central plane of the body, t is the time, and t is the fitting parameter wherein:

$$τ = \frac{1}{{s}^{2} α} , s = \frac{n π}{2 L} , and α \frac{k}{ρ {c}_{p}} ,$$

and wherein ρ is the density of the body, and cₚ is the heat capacity of the body. Optionally, the method further comprises the step of calculating the thermal diffusivity of the body.

In a further embodiment, there is provided an apparatus for measuring at least one thermal property of an electrochemical cell, the apparatus comprising: a first heat sink; a first thermal control element coupled to the first heat sink and configured to be coupled to the electrochemical cell; a controller configured to control the first thermal control element to maintain a first surface of the electrochemical cell at a constant temperature for a predetermined time period by rejecting heat to the first heat sink; a first heat flux sensor coupled to the first thermal control element and configured to measure the heat flux through a first surface of the electrochemical cell.

Optionally, the thermal control element is a Peltier element.

Optionally, the heat flux sensor is configured to have a signal to noise ratio of at least 3:1, and preferably of at least 10:1.

Optionally, the apparatus comprises a second thermal control element coupled to the first heat sink or a second heat sink and configured to be coupled to the electrochemical cell, and a second heat flux sensor coupled to the second thermal control element and configured to measure the heat flux through a second surface of the electrochemical cell, and wherein the first surface and the second surface are opposite faces of the electrochemical cell.

Optionally, the controller is configured to control the first thermal control element and the second thermal control element to maintain the first surface and the second surface of the electrochemical cell at the same temperature for a predetermined period.

### BRIEF DESCRIPTION OF THE DRAWINGS

FIG. 1a shows a schematic for a testing apparatus for an electrochemical cell according to an embodiment.

FIG. 1b shows an alternative testing apparatus for an electrochemical cell according to another embodiment.

FIG. 2 is a flow chart depicting a method for characterising a thermal property of a body according to an embodiment.

FIG. 3 is a chart showing the evolution of the temperature profile across a cell subject to internal heat generation whilst the temperature of the surfaces are fixed.

FIG. 4 is a chart showing the measured heat flux through the surface of the cell of during the internal heat generation shown in FIG. 3.

FIG. 5 is a chart showing the final temperature profile across the cell subject to internal heat generation and the energy stored under the temperature profile.

FIG. 6 is a chart showing the heat flux passed through the surface during the heat generation in the cell which resulted in the temperature profile shown in FIG. 5.

FIG. 7 is a flow chart depicting an alternative method for characterising a thermal property of a body according to another embodiment.

FIG. 8 is a chart showing the evolution of the temperature profile across a cell subject to a step change in temperature.

FIG. 9 is a chart showing the measured heat flux through the surface of the cell subject to the step change of FIG. 8.

### DETAILED DESCRIPTION

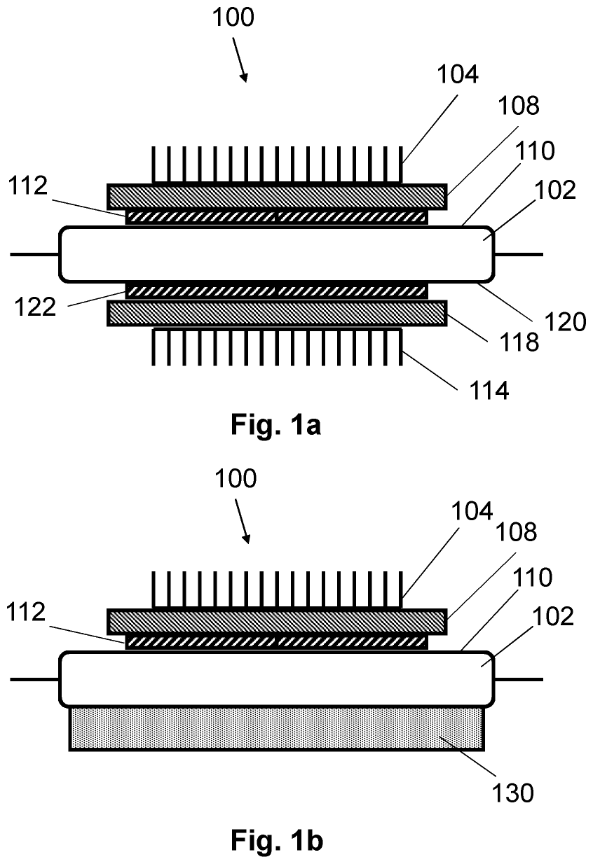

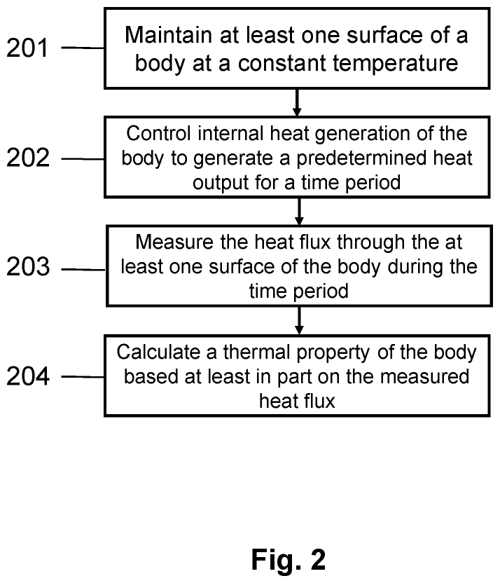

FIG. 1a shows a testing apparatus 100 for measuring at least one thermal property of an electrochemical cell 102. The apparatus 100 includes a first heat sink 104 and a second heat sink 114. The first heat sink 104 and the second heat sink 114 are shown in FIG. 1a as a structure with fins for rejecting heat to the environment. However, it is not essential that a heat sink be configured as such. The first heat sink 104 and the second heat sink 114 may comprise any structure which allows heat to be rejected from the electrochemical cell 102 or provide heat to the electrochemical cell 102. For example, the heat sink may comprise a liquid cooling system to carry heat away from the electrochemical cell. The heat sink may also include one or more heating elements to provide heat energy to the electrochemical cell 102 and therefore increase the temperature of the surface of the electrochemical cell.

The apparatus 100 comprises a first thermal control element 108 which is coupled to the first heat sink 104 and is configured to be coupled to the electrochemical cell 102. The first thermal control element 108 is thermally coupled to the first heat sink 104 such that it may be controlled to finely adjust the temperature on a first surface 110 of the electrochemical cell. The first surface 110 of the electrochemical cell 102 is coupled to a first side of the first thermal control element 108. The thermal control element 108 may be controlled by adjusting an electrical signal applied to the thermal control element 108. The electrical signal applied to the thermal control element may promote or restrict the heat transfer through the thermal control element from a hot side to a cold side. In the case where the heat sink 104 provides cooling to the electrochemical cell, the hot side of the thermal control element is positioned closest to the electrochemical cell and the cold side of the thermal control element is coupled to the heat sink. In the case where the heat sink 104 provides heating to the electrochemical cell 102, the cold side of the thermal control element is positioned closest to the electrochemical cell and the hot side is coupled to the heat sink (i.e. the thermal control element is flipped). The thermal control element 108 provides for control of the rate of heat transfer from the hot side to the cold side. The first thermal control element 108 may comprise a Peltier element. In the case of a Peltier element, the rate of heat transfer from the hot side to the cold side, and therefore the fine control of temperature of the side closest to the electrochemical cell is done by way of the thermoelectric effect.

The apparatus 100 also comprises a controller (not shown in the figures) which is configured to control the first thermal control element 108. The controller is configured to maintain the first surface of the electrochemical cell at a constant temperature for a predetermined time period by controlling the rejection of heat to the first heat sink. Specifically, the controller may control the rate of heat transfer from the hot side of the thermal control element to the cold side of the thermal control element such that the temperature of the first surface of the electrochemical cell is held at a fixed value. The controller may receive signals indicative of the temperature of the first surface of the electrochemical cell as feedback so that the controller may adjust the rate of heat transfer through the thermal control element to maintain the temperature of the first surface of the electrochemical cell at the fixed value.

The apparatus 100 comprises a first heat flux sensor 112 coupled to the first thermal control element 108, and configured to measure the heat flux through the first surface 110 of the electrochemical cell 102. The heat flux sensor 112 may be sandwiched between the electrochemical cell 102 and the thermal control element 108 so that heat may be transferred through the heat flux sensor 112, either from the electrochemical cell 102 and to the heat sink 104 via the thermal control element 108 (in the case where the heat sink 104 is configured to provide cooling), or from the heat sink 104 to the electrochemical cell 102 via the thermal control element (in the case where the heat sink 104 is configured to provide heating).

As shown in FIG. 1a, the second heat sink 114 is disposed on an opposite side of the electrochemical cell 102 to the first heat sink 104. The apparatus 100 further comprises a second thermal control element 118 coupled to the second heat sink 114 and which is configured to be coupled to the electrochemical cell 102. The second thermal control element 118 is thermally coupled to the second heat sink 114 such that the second thermal control element 118 may be controlled to finely adjust the temperature on a second surface 120 of the electrochemical cell 102. The second surface 120 of the electrochemical cell 102 is coupled to a first side of the second thermal control element 118. The second thermal control element 118 may be controlled by adjusting an electrical signal applied to the thermal control element 118. The second thermal control element 118 may be configured and controlled in the same way as described for the first thermal control element 108. However, the second thermal control element 118 is disposed on the opposite side of the electrochemical cell 102 to the first thermal control element 108. The second thermal control element 118 is coupled to the electrochemical cell 102 by a second heat flux sensor 122. The second thermal control element 118 may comprise a Peltier element. The second thermal control element 118 may be configured for heating the surface of the electrochemical cell 102 where the second heat sink 114 provides heating or the second thermal control element 118 may be configured for cooling the surface of the electrochemical cell 102 where the second heat sink 114 provides cooling. The second thermal control element 118 may be controlled by the same controller as the first thermal control element 108, or by a separate controller.

As an alternative to using two heat sinks, the same first heat sink 104 may be coupled to both the first thermal control element 108 and the second thermal control element 118. For example, a single cooling or heating apparatus may be coupled to both the first thermal control element 108 and the second thermal control element 118 to provide cooling or heating to both thermal control elements. The single first heat sink 104 may be coupled to both thermal control elements 108,118 by a thermal conduit such as liquid cooling or a heat pipe.

The first heat flux sensor 112 and/or the second heat flux sensor 122 may be chosen so as to have a signal which may be detected above the level of noise from the heat flux sensors. The ratio of the level of the signal compared to the level of noise from the heat flux sensor is known as the signal to noise ratio. A higher signal to noise ratio denotes a signal which is stronger than the level of the noise. When smaller values of or differences in heat flux are to be recorded by a heat flux sensor, the signal to noise ratio may become more significant since this means the desired signal will be drowned out by the noise in the signal. The heat flux sensor(s) may be chosen to have a signal to noise ratio of at least 3:1, or preferably a signal to noise ratio of at least 10:1.

In an alternative arrangement shown in FIG. 1b, the electrochemical cell 102 may be heated or cooled from one side only. As shown in FIG. 1b, the electrochemical cell 102 is coupled on a first surface 110 to a first heat sink 104, via a first thermal control element 108 and a first heat flux sensor 112. The second surface 120 of the electrochemical cell 102 is coupled to insulation 130 which insulates the second surface 120. In this way, the temperature of the second surface 120 of the electrochemical cell 102 is not controlled, but the heat flux through the second surface 120 is minimised. This results in a boundary condition at the first surface 110 of a fixed temperature and a boundary condition at the second surface 120 of zero heat flux. Advantageously, this may allow accurate measurement of thermal properties of an electrochemical cell subject to non-uniform internal heating. For example, in the situation where internal heat generation occurs predominantly in the vicinity of the first surface 110 of the electrochemical cell, insulation of the second surface 120 may provide a more uniform measurement of the thermal properties.

The first heat flux sensor 112 and/or the second heat flux sensor 122 may each comprise a single heat flux sensor unit, or may comprise two or more heat flux sensor units in parallel sandwiched between the electrochemical cell 102 and the respective thermal control element. More heat flux sensor units may be used if a greater portion of the surface area of the electrochemical cell 102 is desired to be measured for heat flux. However, it is not necessary to cover the entire surface area of the electrochemical cell 102 with a heat flux sensor. A heat flux sensor may be configured to only cover a portion of the surface of the electrochemical cell 102 and the heat flux may be extrapolated to the remainder of the uncovered portion of the surface of the electrochemical cell.

### Testing Methods

The following sections outline methods for determining the thermal diffusivity of electrochemical or lithium-ion cells. All three methods use a similar concept which overcomes the limitations of other methods which either directly or indirectly apply a thermal gradient to a cell to determine the thermal properties. The techniques are applicable to any body (homogeneous or composite, and having isotropic or anisotropic thermal properties). For example, the methods may be useful in determining the thermal properties of bioreactors where it is useful to know the thermal diffusivity so as to be able to finely control the temperature and control the rate of reaction.

Where the current flow in an electrochemical cell is controlled, this may be done by adjusting a voltage applied to the terminals or tabs on the cell to cause the cell to either charge or discharge. It will be understood by the skilled person that current control in an electrochemical cell may be done by controlling the voltage applied to terminals or tabs and that the power of charge and discharge of the cell may also be controlled by controlling the current flow in the electrochemical cell. Current control may be done in an alternating way such that the overall charge of the cell does not vary over the period of the test. For example, the cell may be slightly discharged to cause a current to flow in the cell and then charged again to cause a current to flow in the opposite direction in the cell. Both charging and discharging cause internal heating in the cell, but the state of charge of the cell is unchanged.

Where test data is fit to a model, a minimisation routine may be used for example, a least squares method. The minimisation routine may adjust a chosen parameter, such as thermal diffusivity, until the model output most closely matches the heat flux test data. The minimisation routine may prioritise some of the data over other data. For example, in FIG. 4, the heat flux data from 0 to 600 seconds is used to fit the data since the shape of the curve is more significant over this region than where the model tends to a limit at say 1400 seconds.

### Method 1. Constant Internal Heat Generation

In a first step 201 of first method of measuring the thermal diffusivity of a body, at least one surface of the body is held at a constant temperature. The temperature of the at least one surface of the body may be controlled by either removing heat from the surface or by applying heat to the surface. When the body is generating heat internally, the surface temperature of the body will tend to increase over time. The surface temperature may be reduced back down to the constant temperature by increasing a rate of cooling provided at the surface of the body.

In a second step 202, an internal heat generation of the body is controlled to generate a predetermined heat output for a time period. For example, where the body is an electrochemical cell, the current flow in the electrochemical cell may be electrically controlled by allowing a charging or a discharging current to flow. Since the electrical characteristics of the cell are known (the voltage level and the current flow), the internal heat generation may be simply calculated from Power=Voltage×Current.

The current flow in the electrochemical cell may be controlled by alternating between a charging current and a discharging current. In this way, the level of charge of the electrochemical cell remains constant over the time period because the electrochemical cell is continuously charged as much as it is discharged. However, because there is a current flow in the cell, heat is still internally generated. The current flow may be controlled to generate a constant heat output in the electrochemical cell during the time period.

In a third step 203, the heat flux through the at least one surface of the body during the time period is measured. The heat flux may be measured using a heat flux sensor which provides a voltage output proportional to the heat flux through the sensor.

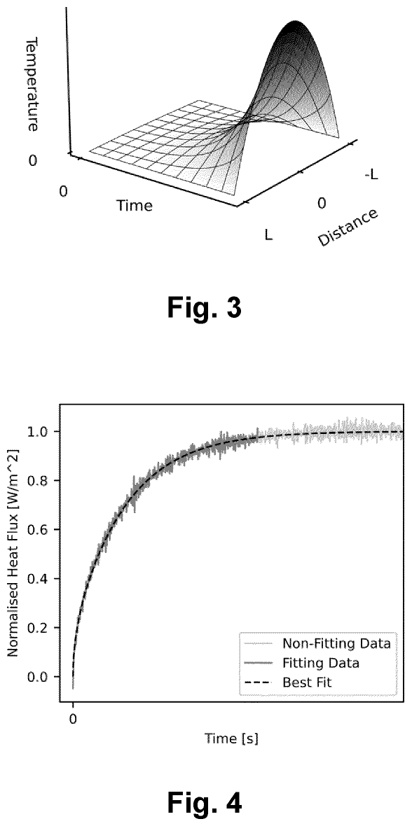

In a fourth step 204, a thermal property of the body is calculated based at least in part on the measured heat flux. FIG. 3 depicts an exemplary temperature profile across the thickness of a pouch cell as it evolves over time. On the distance axis, zero denotes the centre of the cell mid-way between the first and second surfaces of the electrochemical cell. L is the location at the first surface of the cell and −L is the location at the second surface of the cell. Starting from the right and progressing left along the time axis, as the internal generation of heat in the cell remains constant, the temperature profile evolves to the final shape at the left end of the time axis. Further, as the bulk temperature of the cell increases, in order for the temperature at each surface (L and −L) of the cell to remain constant, the heat flux through the surfaces must increase. The heat flux through the surfaces of the electrochemical cell are measured and the data plotted in FIG. 4.

As can be seen in FIG. 4, the heat flux through the surfaces of the electrochemical cell increases over time. The heat flux increase is quick at first as the temperature profile of the cell rapidly develops, and tends to a steady state over time.

The measured heat flux over the time period may be plotted as shown in FIG. 4 and fit to the fitting equation:

$$\dot{q} = {\sum }_{n = 1 , 3 , 5 …}^{∞} ( - ( \frac{{\dot{e}}_{g e n} L}{2} ) {( \frac{4}{π n} )}^{2} ) {e}^{- \frac{t}{τ}}$$

\dot{q} is the heat flux in W/m·K (Watts per metre Kelvin) which is measured from the heat flux sensor(s). ė_{gen} is the internal heat generation in W/m³ and can be calculated from the current flow and the voltage of the electrochemical cell. L is the transverse distance in metres between the at least one surface and a central plane of the electrochemical cell. L can be calculated as one half of the thickness of the whole electrochemical cell. t is the time measured in seconds. τ is a fitting parameter wherein:

$$τ = \frac{1}{{s}^{2} α} , s = \frac{n π}{2 L} , and α \frac{k}{ρ {c}_{p}} ,$$

ρ is the density of the body in kg/m³, cₚ is the heat capacity of the electrochemical cell in J/K (Joules per Kelvin), and k is the thermal diffusivity of the body in m²/s (square metres per second).

Since the internal heat generation, the thickness of the electrochemical cell, the density of the electrochemical cell, and the heat capacity of the electrochemical cell are known, fitting the measured heat flux to the above equation results in the calculation of the unknown value of thermal diffusivity. In this way, a value for thermal diffusivity of the electrochemical cell is calculated using data from a physical test which does not rely on a gradient of temperature across the electrochemical cell.

### Method 2. Energy Absorption

In a first step 201 of second method of measuring the thermal diffusivity of a body, at least one surface of the body is held at a constant temperature. The temperature of the at least one surface of the body may be controlled by either removing heat from the surface or by applying heat to the surface. When the body is generating heat internally, the surface temperature of the body will tend to increase over time. The surface temperature may be reduced back down to the constant temperature by increasing a rate of cooling provided at the surface of the body.

In a second step 202, an internal heat generation of the body is controlled to generate a predetermined heat output for a time period. For example, where the body is an electrochemical cell, the current flow in the electrochemical cell may be electrically controlled by allowing a charging or a discharging current to flow. Since the electrical characteristics of the cell are known (the voltage level and the current flow), the internal heat generation may be simply calculated from Power=Voltage×Current

In a third step 203, the heat flux through the at least one surface of the body during the time period is measured. The heat flux may be measured using a heat flux sensor which provides a voltage output proportional to the heat flux through the sensor.

In a fourth step 204, a thermal property of the body is calculated based at least in part on the measured heat flux.

The heat stored under a steady state temperature profile may be used to calculate the thermal diffusivity of the electrochemical cell. At a steady state (e.g. after a sufficient amount of time has passed that the temperature profile of the cell shown in FIG. 3 no longer changes), the average temperature from the temperature profile may be given by:

$${T}_{A v} = \frac{{\dot{e}}_{g e n} {L}^{2}}{3 k} + {T}_{w a l l}$$

T_{Av} is the average temperature in K. T_{wall} is the temperature fixed at the surface of the cell in K. ė_{gen} is the internal heat generation in W/m³ and can be calculated from the current flow and the voltage of the electrochemical cell. L is the transverse distance in metres between the at least one surface and a central plane of the electrochemical cell. k is the thermal conductivity of the cell in W/m·K.

The difference between the average temperature and the initial temperature can be used to find the change in energy of the body according to:

$$Δ E = m {c}_{p} ( {T}_{A v} - {T}_{0} )$$

ΔE is the change in energy in J. T₀ is the initial temperature of the electrochemical cell in K. m is the mass of the cell in kg. cₚ is the heat capacity of the electrochemical cell in J/K (Joules per Kelvin).

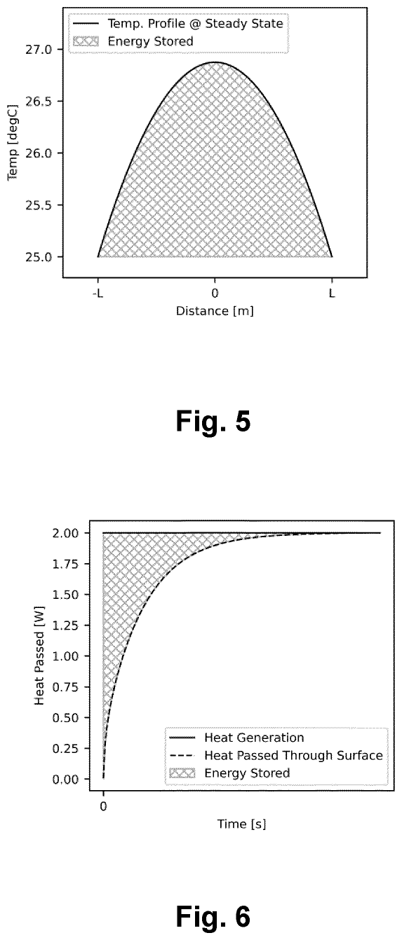

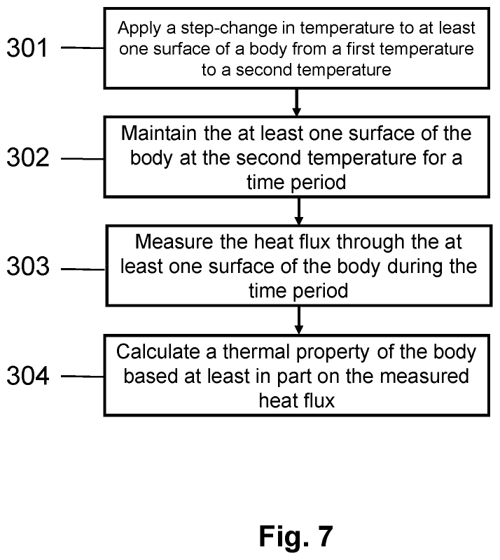

The steady state temperature profile takes time to develop as some of the heat generated in the electrochemical cell is stored. Over time, the amount of heat stored in the cell reduces until the steady state is reached. At this point, the heat passed out of the body equals the heat generation rate. FIG. 5 shows the temperature profile across the thickness of the cell when the cell is in the steady state condition (i.e. at the end of the time period). The shaded area under the temperature profile is equivalent to the thermal energy stored in the electrochemical cell under a steady state. FIG. 6 shows the heat passed through the surface of the cell (as measured by the heat flux sensor). The shaded area to the left of the heat flux profile is equivalent to the energy rejected by the electrochemical cell during the test.

The energy stored under the steady state temperature profile as shown in FIG. 5 can be calculated as:

$$E = m {c}_{p} \frac{{\dot{e}}_{gen} {L}^{2}}{3 k}$$

The energy passed through the surface of the cell as shown in FIG. 6 is:

E=A∫\dot{q}dt

The energy stored under the steady state temperature profile and the energy passed through the surface of the cell can be equated as:

$$A \int \dot{q} dt = m {c}_{p} \frac{{\dot{e}}_{g e n} {L}^{2}}{3 k}$$

Since:

$$\frac{{c}_{p}}{k} = \frac{1}{α ρ} {\dot{e}}_{g e n} = \frac{\dot{Q}}{V}$$

Wherein ė_{gen} is the internal heat generation in W/m³ and can be calculated from the current flow, the voltage and the volume of the electrochemical cell. Q is the rate of heat generation in Watts and V is the volume of the cell in m³.

The thermal diffusivity of the electrochemical cell can be calculated from:

$$α = \frac{\dot{Q} {L}^{2}}{3 A \int \dot{q} d t}$$

Where:

$$α = \frac{k}{ρ {c}_{p}}$$

And α is the thermal diffusivity of the cell in m²/s. Since the internal heat generation is known from the current flow in the cell, the surface area and thickness of the cell are known, the heat flux through the surface of the cell is known, and the density and specific heat capacity of the cell may be measured, the thermal diffusivity may be calculated.

The density of the cell may be conventionally measured by weighing and measuring the volume. Similarly, the heat capacity of the cell may be measured using calorimetry, specifically recording the bulk temperature change resulting from a known heat input.

### Method 3. Step Change in Temperature

In a first step 301 of third method of measuring the thermal diffusivity of a body a step change in temperature is applied to at least one surface of the body from a first temperature to a second temperature. The body may be an electrochemical cell. The cell may have been held at the first temperature for an extended period of time such that the entirety of the cell is known to be at a constant temperature. The step change in temperature may be applied to the surface of the cell using the apparatus shown in FIG. 1a or 1b. The second temperature may be higher or lower than the first temperature which may be achieved using either heating or cooling to effect the step change.

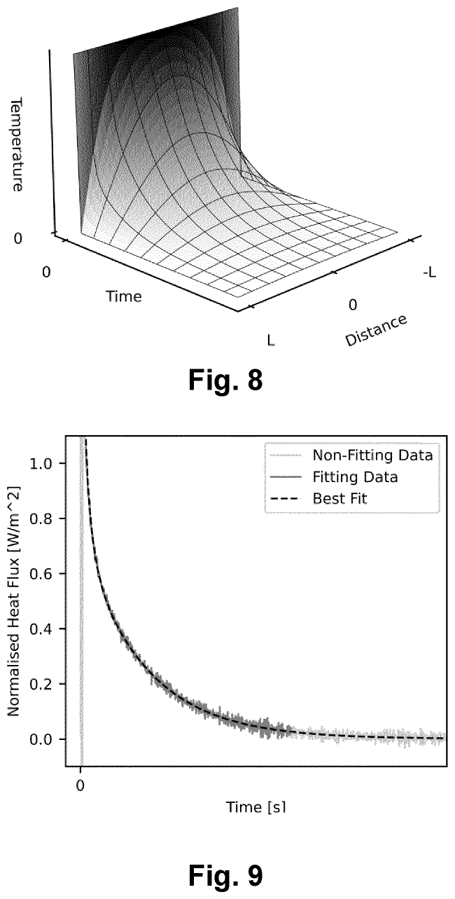

In a second step 302, the at least one surface of the body may be maintained at the second temperature for a time period. Once the step change has been applied, heat will pass through the surface of the body and the temperature of the body will begin to approach the second temperature. Such a step change in temperature may be seen in FIG. 8. At time=0, the step change in temperature is applied to the surface at distance L and −L. The surface immediately cools from the first temperature to the second temperature. Over the time period, the remainder of the cell more slowly cools from the first temperature to the second temperature until the whole of the cell reaches the second temperature.

In a third step 303, the heat flux through the at least one surface of the body is measured during the time period. FIG. 9 shows an exemplary measured heat flux. At time=0 the step change is applied over a few seconds. Early on in the time period, the heat flux through the surface is high as the difference in the temperature of the cell and the second temperature is greatest. As the bulk of the cell approaches the second temperature, the heat flux through the surface gradually reduces.

In a fourth step 304, the thermal property is calculated based at least in part on the measured heat flux.

The shape of the temperature profile as shown in FIG. 8 may be approximated using Fourier series where the boundaries are:

$$\begin{matrix}f ( x ) = 1 & x [ - 2 L , - L ] \\ f ( x ) = - 1 & x [ - L , L ] \\ f ( x ) = 1 & x [ L , 2 L ]\end{matrix}$$

And the Fourier series equation is:

$$f ( x ) = {a}_{0} + {\sum }_{n = 1}^{∞} ( {a}_{n} cos \frac{n π x}{L} + {b}_{n} sin \frac{n π x}{L} )$$

As the function is symmetric about the x and y axis:

$${a}_{0} = {b}_{n} = 0$$

Therefore:

$$f ( x ) = {\sum }_{n = 1}^{∞} ( {a}_{n} cos ( \frac{n π x}{L} ) )$$

And by integrating over the piecewise function:

$${a}_{n} = ( \frac{4}{π n} ) sin ( \frac{π n}{2} )$$

Which gives:

$$f ( x ) = {\sum }_{n = 1}^{∞} ( ( \frac{4}{π n} ) sin ( \frac{π n}{2} ) cos ( \frac{n π x}{L} ) )$$

By multiplying equation constants, the initial shape at time=0 is given by:

$$u ( t ) = {\sum }_{n = 1}^{∞} ( ( \frac{4 Δ T}{π n} ) sin ( \frac{π n}{2} ) cos ( \frac{n π x}{L} ) ) + {T}_{1}$$

Where:
ΔT=Magnitude of the step change on the surface of the cell and T₁ is the first temperature.

The solution to the equation describing the shape of the temperature profile may be given by the separation of variables method:

$$u ( x , t ) = X ( x ) T ( t ) = [ A sin ( sx ) + B cos ( sx ) ] {e}^{- {s}^{2} α t}$$

Where A, B and s are constants. To find the constants boundary conditions must be applied.

### Boundary Condition 1:

The first boundary condition applied describes the temperature at the surface for all time periods. The temperature at the first surface is set to the new temperature, 0. The temperature at the second surface is set to the new temperature, 0.

$$At x = L then u = 0 \\ At x = - L then u = 0$$

Therefore:

$$X ( L ) T ( t ) = 0 and X ( - L ) T ( t ) = 0$$

So:

$$X ( L ) = X ( - L )$$

Which means:

$$A sin ( sL ) + B cos ( sL ) = A sin ( - sL ) + B cos ( - sL )$$

This can only be satisfied if:
A=0

### Boundary Condition 2:

The second boundary condition describes the initial internal temperature profile at t=0. The temperature throughout the body is at 1 except at surface 1 and surface 2 where it is zero. This is effectively a step function which is represented as an infinite Fourier series.
At t=0 and x=0
The temperature is given by: (use version without constants for simplification)

$$u ( t ) = {\sum }_{n = 1}^{∞} ( ( \frac{4}{π n} ) sin ( \frac{π n}{2} ) cos ( \frac{n π x}{L} ) )$$

Therefore:

u(x,t)=[B cos(s0)]e⁰

So:

$$B = {\sum }_{n = 1}^{∞} ( ( \frac{4}{π n} ) sin ( \frac{π n}{2} ) )$$

### Boundary Condition 3:

The third boundary condition is used to constrain the temperature to 0 at t=0 at the surface of the body. As the equations are symmetric about x=0 only one surface needs to be constrained.
At t=0 x=L u=0

### Gives:

0=[B cos(sL)]e⁰

We know B is non-zero, therefore, where n, is an odd integer:

$$sL = \frac{n π}{2} for n = 1 , 3 , 5 …$$

### Or:

$$s = \frac{n π}{2 L} for n = 1 , 3 , 5 …$$

This results in the solution that:

$$u ( x , t ) = [ B cos ( sx ) ] {e}^{- \frac{t}{τ}}$$

Where:

$$B = {\sum }_{n = 1 , 3 , 5 …}^{∞} ( ( \frac{4 Δ T}{π n} ) sin ( \frac{π n}{2} ) ) \\ s = \frac{n π}{2 L} \\ τ = \frac{1}{{s}^{2} α} \\ α = \frac{k}{ρ {C}_{p}}$$

This can be used to find the heat flux at the surface of the cell:

Find du/dx at x=L

$$\frac{du}{dx} = {\sum }_{n = 1 , 3 , 5 …}^{∞} ( - ( \frac{4}{π n} ) ( \frac{n π}{2 L} ) . sin ( \frac{π n}{2} ) . sin ( \frac{n π x}{2 L} ) ) {e}^{- \frac{t}{τ}}$$

Sub in, x=L and simplify:

$$\frac{du}{dx} ( x = L ) = {\sum }_{n = 1 , 3 , 5 …}^{∞} ( - ( \frac{2}{L} ) . {sin}^{2} ( \frac{π n}{2} ) ) {e}^{- \frac{t}{τ}}$$

And we know:

$$for n = 1 , 3 , 5 … {sin}^{2} ( \frac{π n}{2} ) = 1$$

And also, multiplying by the step change size scalar:

$$\frac{du}{dx} ( L ) = \frac{\dot{q}}{k} = {\sum }_{n = 1 , 3 , 5 …}^{∞} ( - \frac{2 Δ T}{L} ) {e}^{- \frac{t}{τ}}$$

Or heat flux, \dot{q}:

$$\dot{q} = {\sum }_{n = 1 , 3 , 5 …}^{∞} ( - \frac{2 k Δ T}{L} ) {e}^{- \frac{t}{τ}}$$

Which describes the heat flux evolution from the initial condition of the steady state heat equation. Since the step change in temperature, the thickness of the cell, the density and the heat capacity of the cell are known, the thermal diffusivity may be calculated by fitting the heat flux \dot{q} measured at the surface of the cell to the equation:

$$\dot{q} = {\sum }_{n = 1 , 3 , 5 …}^{∞} ( - \frac{2 k Δ T}{L} ) {e}^{- \frac{t}{τ}}$$

This is shown in FIG. 9, where the best fit line is fit to the measured heat flux data. Applying a step change in temperature may not be instant. Since it will take some amount of time for the surface of the cell to reach the second temperature. However, the step change in temperature may be sufficiently shorter than the time period over which the surface of the cell is held at the second temperature such that the transition of the surface from the first temperature to the second temperature is effectively a step change. The time period may be more than 50 times the amount of time taken to apply the step change in temperature, preferably more than 100 times, and even more preferably more than 200 times the amount of time taken to apply the step change in temperature.

1. A method of measuring at least one thermal property of a body comprising the steps of:
maintaining at least one surface of the body at a constant temperature;
controlling an internal heat generation of the body to generate a predetermined heat output for a time period;
measuring the heat flux through the at least one surface of the body during the time period; and
calculating the thermal property based at least in part on the measured heat flux.

2. The method of claim 1, wherein the step of maintaining at least one surface of the body at a constant temperature comprises maintaining a first surface of the body at a constant temperature and maintaining a second surface of the body at a constant temperature.

3. The method of claim 2, wherein the first surface and the second surface are maintained at the same constant temperature.

4. The method of claim 2 or claim 3, wherein the first surface and the second surface are selected such that a temperature profile across the body from the first surface to the second surface is symmetrical.

5. The method of any preceding claim, wherein the body is an electrochemical cell.

6. The method of claim 5, wherein the electrochemical cell is one of a prismatic cell, a pouch cell, or a cylindrical cell.

7. The method of claim 5 or claim 6, wherein the step of controlling the internal heat generation of the electrochemical cell comprises controlling a current flow in the electrochemical cell.

8. The method of claim 7, wherein the current flow in the electrochemical cell is alternated between a charging current and a discharging current such that the level of charge of the electrochemical cell remains constant over the time period.

9. The method of claim 7 or claim 8, wherein the current flow is controlled to generate a constant heat output in the electrochemical cell during the time period.

10. The method of any preceding claim, wherein the heat flux through the at least one surface of the body is measured using one or more heat flux sensors.

11. The method of any preceding claim, wherein the measured heat flux over the predetermined time period is fit to the fitting equation:
$$\dot{q} = {\sum }_{n = 1 , 3 , 5 …}^{∞} ( - ( \frac{{\dot{e}}_{gen} L}{2} ) {( \frac{4}{π n} )}^{2} ) {e}^{- \frac{t}{τ}}$$
wherein \dot{q} is the heat flux (W/m·K), ėgen is the internal heat generation (W/m³) calculated from the current flow, L is the transverse distance (m) between the at least one surface and a central plane of the body, τ is the time(s), and t is the fitting parameter wherein:
$$τ = \frac{1}{{s}^{2} α} , s = \frac{n π}{2 L} , and α = \frac{k}{ρ {C}_{p}} ,$$
and wherein ρ is the density of the body (kg/m³), Cₚ is the heat capacity of the body (J/kg·K), k is the thermal conductivity of the body (W/m·K), and α is the thermal diffusivity of the body (m²/s).

12. The method of claim 11, further comprising the step of calculating the thermal diffusivity of the body.

13. The method of claim 11 or claim 12, wherein the thermal diffusivity is calculated by an error minimisation routine to match the measured heat flux to the heat flux calculated by the fitting equation.

14. The method of any one of claims 1 to 10, wherein the thermal diffusivity is calculated by integrating the heat flux during the time period and equating the absorbed energy with the stored energy.

15. The method of claim 14, wherein the absorbed energy and the stored energy are equated such that:
$$α = \frac{\dot{Q} {L}^{2}}{3 A \int \dot{q} dt}$$
wherein \dot{Q} is the heat generated in the body (W), L is the transverse distance (m) between the at least one surface and a central plane of the body, A is the area (m²) of the at least one surface, q is the heat flux (W/m·K) through the at least one surface, t is the time(s), and:
$$α = \frac{k}{ρ {C}_{p}}$$
wherein ρ is the density of the body (kg/m³), Cₚ is the heat capacity of the body (J/kg·K), k is the thermal conductivity (W/m·K) of the body, and α is the thermal diffusivity (m²/s) of the body, the method further comprising the step of calculating the thermal diffusivity of the body.

16. The method of any one of claims 11 to 15, wherein the heat capacity of the body is measured by calorimetry.

17. A method of measuring at least one thermal property of a body comprising the steps of:
applying a step-change in temperature to at least one surface of the body from a first temperature to a second temperature;
maintaining the at least one surface of the body at the second temperature for a time period; measuring the heat flux through the at least one surface of the body during the time period; and
calculating the thermal property based at least in part on the measured heat flux.

18. The method of claim 17, wherein the step of applying a step-change in temperature comprises heating the at least one surface of the body from the first temperature to the second temperature using a heater.

19. The method of claim 17, wherein the step of applying a step-change in temperature comprises cooling the at least one surface of the body from the first temperature to the second temperature using a cooler.

20. The method of any one of claims 17 to 19, wherein the at least one surface of the body is maintained at the second temperature for more than 50 times, preferably more than 100 times, and more preferably more than 200 times the amount of time taken to apply the step-change.

21. The method of any one of claims 17 to 20, wherein the measured heat flux over the predetermined time period is fit to the fitting equation:
$$\dot{q} = {\sum }_{n = 1 , 3 , 5 …}^{∞} ( - \frac{2 k Δ T}{L} ) {e}^{- \frac{t}{τ}}$$
wherein \dot{q} is the heat flux (W/m·K), k is the thermal conductivity (W/m·K) of the body, ΔT is the step-change in temperature (K), L is the transverse distance (m) between the at least one surface and a central plane of the body, t is the time(s), and t is the fitting parameter wherein:
$$τ = \frac{1}{{s}^{2} α} , s = \frac{n π}{2 L} , and α = \frac{k}{ρ {C}_{p}} ,$$
and wherein ρ is the density of the body (kg/m³), a is the thermal diffusivity of the body (m²/s) and Cₚ is the heat capacity (J/kg·K) of the body.

22. The method of claim 21 further comprising the step of calculating the thermal diffusivity of the body.

23. An apparatus for measuring at least one thermal property of an electrochemical cell, the apparatus comprising:
a first heat sink;
a first thermal control element coupled to the first heat sink and configured to be coupled to the electrochemical cell;
a controller configured to control the first thermal control element to maintain a first surface of the electrochemical cell at a constant temperature for a predetermined time period by rejecting heat to the first heat sink;
a first heat flux sensor coupled to the first thermal control element and configured to measure the heat flux through a first surface of the electrochemical cell.

24. The apparatus of claim 23, wherein the thermal control element is a Peltier element.

25. The apparatus of claim 23 or claim 24, wherein the heat flux sensor is configured to have a signal to noise ratio of at least 3:1, and preferably of at least 10:1

26. The apparatus of any one of claims 23 to 25, further comprising a second thermal control element coupled to the first heat sink or a second heat sink and configured to be coupled to the electrochemical cell, and a second heat flux sensor coupled to the second thermal control element and configured to measure the heat flux through a second surface of the electrochemical cell, and wherein the first surface and the second surface are opposite faces of the electrochemical cell.

27. The apparatus of claim 26, wherein the controller is configured to control the first thermal control element and the second thermal control element to maintain the first surface and the second surface of the electrochemical cell at the same temperature for a predetermined period.
